(19) United States
(12) Patent Application Publication
(10) Pub. No.: US 2021/0301855 A1
(43) Pub. Date: Sep. 30, 2021

(54) FASTENING ELEMENT

(71) Applicant: WITTE Automotive GmbH, Velbert (DE)

(72) Inventors: Jan Christian Bente, Sprockhövel (DE); Harry Purwin, Ratingen (DE); Philip Weinberger, Essen (DE)

(21) Appl. No.: 17/211,056

(22) Filed: Mar. 24, 2021

(30) Foreign Application Priority Data
Mar. 31, 2020 (DE) 10 2020 204 176.8

(51) Int. Cl. F16B 21/08

(52) U.S. Cl. CPC F16B 21/082; B60Q 1/2626

(57) ABSTRACT

A fastening element for connecting a first component to a second component. The fastening element may have a pin-like connecting element having a first fastening region and a second fastening region. The fastening element may also have a retaining element having a fastening portion which is provided with a receptacle for receiving the first fastening region. The retaining element may be configured for fastening in a cutout of the first component. The second fastening region may have a portion for engaging in a receptacle of the second component. A drive interface may be provided on the connecting element so that the connecting element held in the receptacle is movable.

The invention relates to a fastening element for a component, in particular for fastening to a body component of a vehicle.

EP 2 933 144 A1 discloses a device for at least partially fastening a motor vehicle light in an installation opening of a body of a motor vehicle, a motor vehicle light equipped therewith, and a method for arranging and adjusting such a device on a motor vehicle light. The device comprises a banjo bolt with an external thread and a central opening extending coaxially with the longitudinal axis of the banjo bolt, a threaded bolt which can be fixed to the motor vehicle light and which has a first threaded portion extending through the central opening, as well as a sleeve-shaped clamping part arranged coaxially between the banjo bolt and the threaded bolt in the central opening on the first threaded portion. The banjo bolt has a radially protruding collar which is arranged on one side of the external thread and which faces the motor vehicle light when the device is in the assembled state. The clamping part is rotatably arranged in the central opening. The clamping part is arranged in the axial direction with a positive connection parallel to the longitudinal axis. The clamping part has a continuous axial opening which runs coaxially with the longitudinal axis, the inner diameter of which axial opening is less than the outer diameter of the first threaded portion. The clamping part comprises a projection which has a shape which can be brought into engagement with a tool in order to rotate the clamping part. At least one stop groove is arranged in the collar of the banjo bolt. In addition, a stop fixed on the motor vehicle light is provided, which, when the device is in the assembled state, engages in at least one stop groove. In the method, the threaded bolt is first fixed on the motor vehicle light, then the banjo bolt is screwed onto the first threaded portion, with the clamping part arranged in its central opening with the collar forward, until the stop fixed on the motor vehicle light engages in a stop groove; then an adjustment of the position of the banjo bolt along the threaded bolt relative to the first threaded portion is performed by rotating the clamping part.

The object of the present invention is to provide an improved fastening element.

According to the invention, the object is achieved by a fastening element having the features of claim 1.

Further refinements of the invention are the subject matter of the dependent claims.

A fastening element according to the invention for connecting a first component to a second component has:
a pin-like connecting element having a first fastening region and a second fastening region,
a retaining element having a fastening portion which is provided with a receptacle for receiving the first fastening region, wherein the retaining element is configured for fastening in a cutout of the first component,
   wherein the second fastening region has a portion for engaging in a receptacle of the second component, wherein a drive interface is provided on the connecting element, by means of which the connecting element held in the receptacle can be moved.

The fastening element according to the invention constitutes a releasable tolerance compensation element with subsequent axial adjustment and radial tolerance compensation.

In one embodiment, the retaining element is designed as a clip which is designed to snap into place in the cutout of the first component.

In one embodiment, the portion is designed as a threaded portion.

The threaded portion can be designed as a self-tapping or metric, in particular self-locking, thread which engages positively and/or non-positively in a receptacle of the second component, and which in particular screws into the receptacle.

The fastening element makes it possible to establish a (non-positive and/or positive) connection between two components, for example a vehicle body and a mounted part, for example by simply latching the retaining element in the first component and fastening, for example screwing, the connecting element into the second component. After assembly, the fastening element can be adjusted by moving, for example, rotating the connecting element in the axial direction, and can be separated again by later pulling the connecting element out of the retaining element. In doing so, the adjusted position is preserved for a further fastening.

The first component can be, for example, a carrier component, in particular a body panel of a vehicle.

The second component can be, for example, a mounted part such as a tail light or a side marker light.

In one embodiment, the drive interface is arranged at one end of the connecting element, wherein the drive interface and/or the retaining element is/are designed such that the drive interface is accessible when the first fastening region is arranged in the receptacle. For example, the drive interface can protrude from the receptacle when the first fastening region is arranged in the receptacle. The connecting element can thereby be rotated when the retaining element is fastened, for example locked, in the first component and the connecting element is fastened, for example screwed, in the second component.

In one embodiment, the drive interface is formed for turning the connecting element and comprises in particular an external or internal hexagonal or square head, an external or internal hexalobular driving feature, a slot, or a cross slot. Other shapes of the drive interface are also possible.

In one embodiment, the connecting element is held in the receptacle in a rotatable, releasable manner, but restrained against removal. In this way, the second component can be removed from the first component, and placed back on it. The axial distance adjusted previously in the second component by rotating the connecting element is thereby preserved.

In one embodiment, the fastening element is designed to be elastic in the region of the receptacle.

In one embodiment, the receptacle and the first fastening region have shapes that are complementary to one another. In particular, the receptacle and the first fastening region can have mutually complementary wave shapes and/or a spherical head and/or a spring element and/or a circumferential groove and elastic arms complementary thereto.

In one embodiment, a separating flange is provided on the connecting element to separate the first fastening region from the second fastening region.

In one embodiment, the retaining element furthermore has a head portion which has a larger diameter than the fastening portion. Furthermore, at least two connection regions in the form of flexible, protruding wings can be formed on the fastening portion, which wings are connected to the fastening portion at an end pointing away from the head portion and protrude radially outward at an angle to the head portion and from the fastening portion. The first component can be held between the head portion and a circumferential edge defined by the fastening portions when the retaining element is engaged therein. The flexible wings allow a certain radial play of the fastening element in the first component.

Exemplary embodiments of the invention are explained in greater detail with reference to drawings, in which:

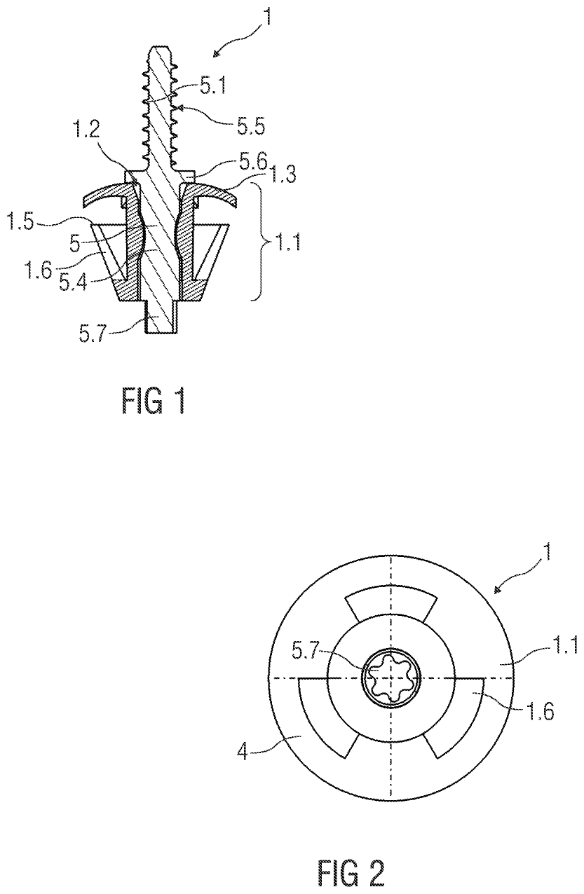

FIG. 1 is a schematic view of a fastening element for compensating for tolerances between two components to be connected,

FIG. 2 is a schematic view of the fastening element from below, with a view of a drive interface,

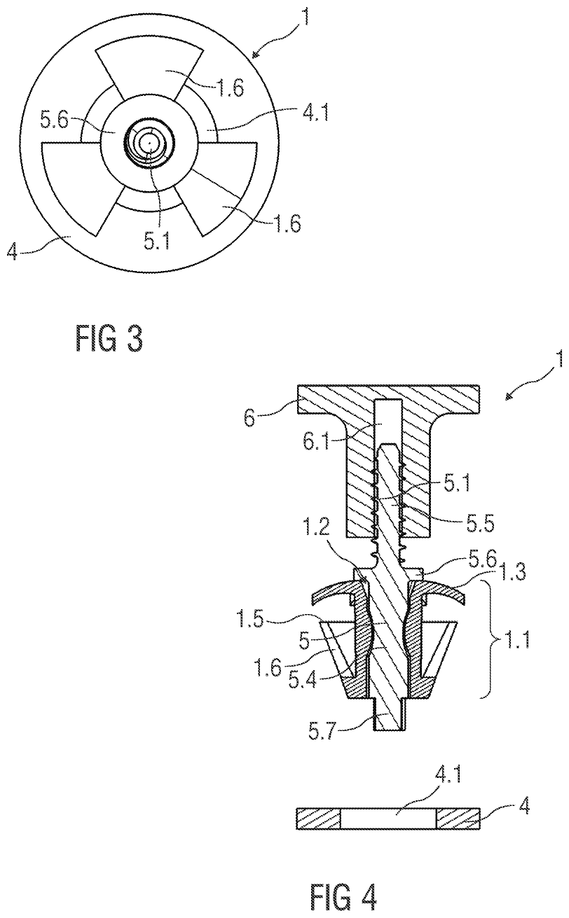

FIG. 3 is a schematic view of the fastening element from above, with a view of a threaded portion,

FIG. 4 is a schematic view of a first component and the fastening element connected to a second component,

FIG. 5 is a schematic isometric view of the arrangement from FIG. 4,

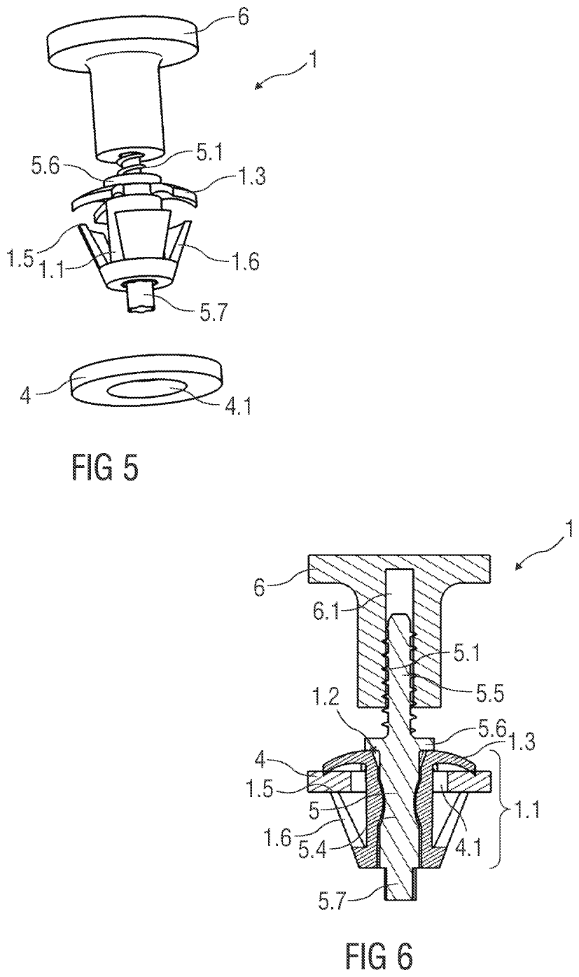

FIG. 6 is a schematic view of the fastening element connected to the second component and the first component connected thereto,

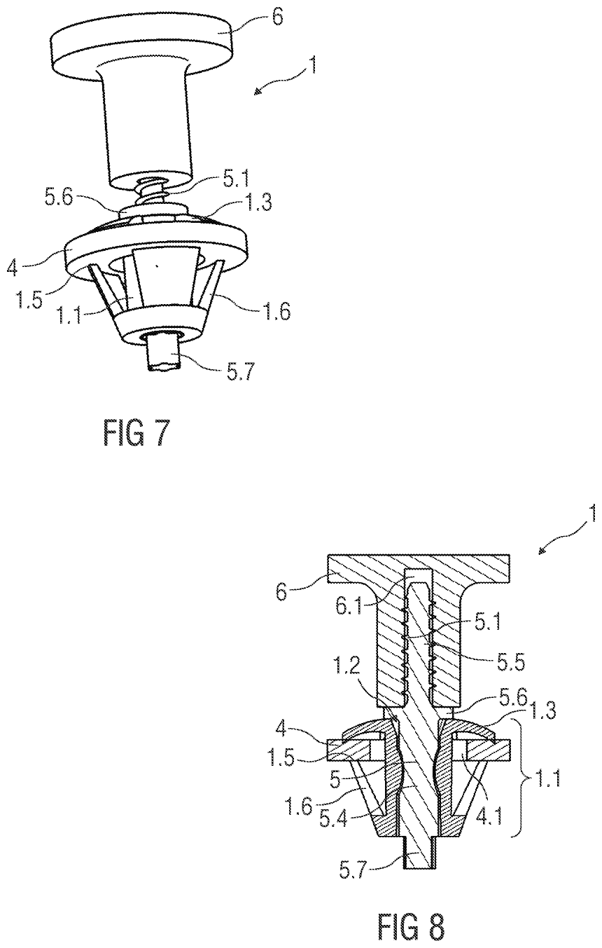

FIG. 7 is a schematic isometric view of the arrangement from FIG. 6,

FIG. 8 is a schematic view of the fastening element connected to the second component and the first component connected therewith after adjusting an axial position,

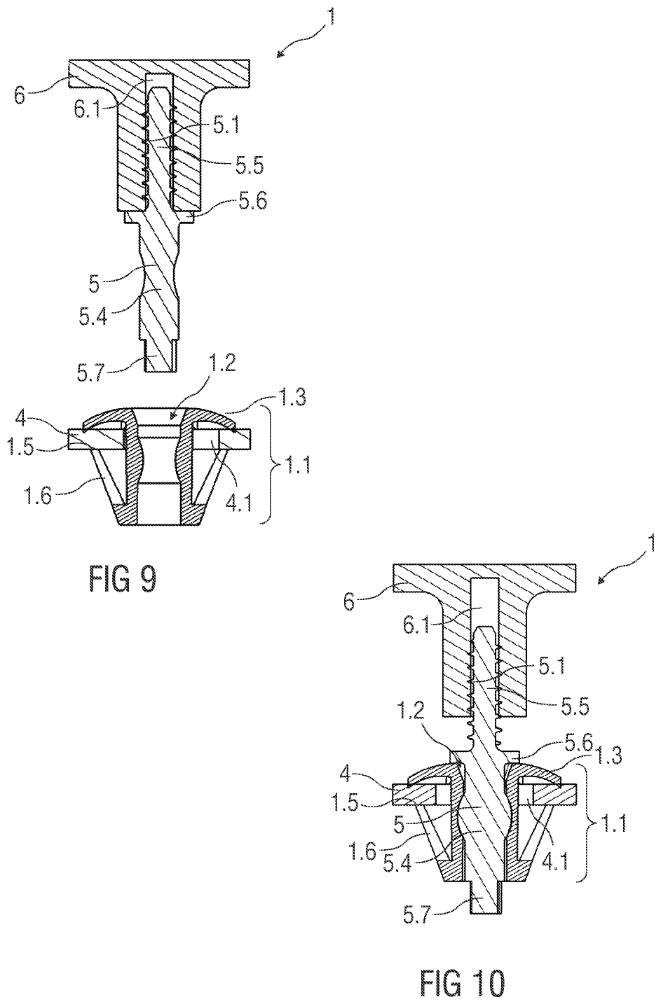

FIG. 9 is a schematic view of the fastening element after the second component has been removed from the first component,

FIG. 10 is a schematic view of an alternative embodiment of the fastening element,

FIG. 11 is a schematic view of a further alternative embodiment of the fastening element,

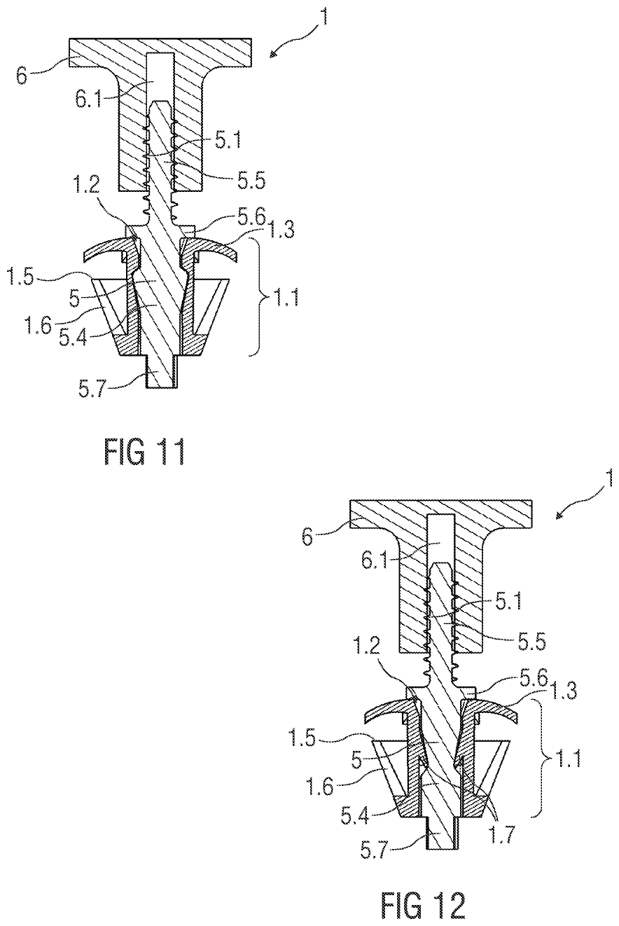

FIG. 12 is a schematic view of a further alternative embodiment of the fastening element,

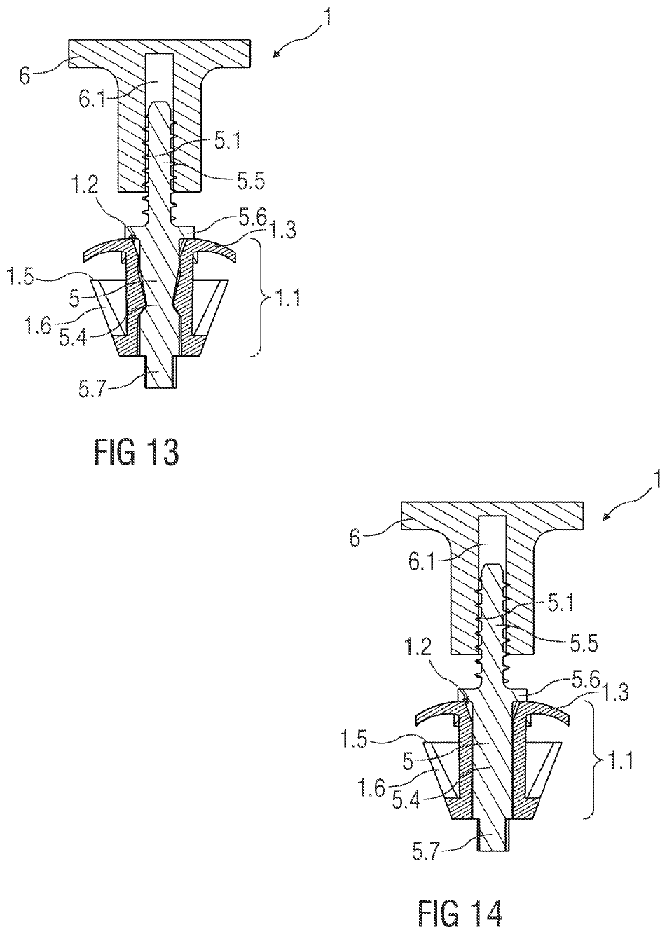

FIG. 13 is a schematic view of a further alternative embodiment of the fastening element,

FIG. 14 is a schematic view of a further alternative embodiment of the fastening element, and

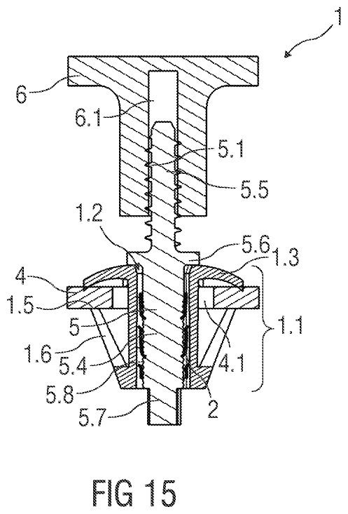

FIG. 15 is a schematic view of a further alternative embodiment of the fastening element.

Corresponding parts are indicated by the same reference numerals in all figures.

FIG. 1 is a schematic view of a fastening element 1 for connecting a first component 4 to a second component 6 and for compensating for tolerances between the first component 4 and the second component 6. FIG. 2 is a schematic view of the fastening element 1 from below, with a view of a drive interface 5.7. FIG. 3 is a schematic view of the fastening element 1 from above, with a view of a threaded portion 5.1.

FIG. 4 is a schematic view of the fastening element 1 connected to the second component 6 and of the separate first component 4. FIG. 5 shows an isometric view of the arrangement from FIG. 4.

The fastening element 1 can be essentially cylindrical and has a fastening portion 1.1 or clip which is provided with a receptacle 1.2. Instead of a clip, a differently designed retaining element can also be provided, which is fastened to the first component (4) in a different way, for example by means of a thread and a nut.

The fastening element 1 can be constructed in one or more parts, and can be formed, for example, from a metal or plastic material or from a combination of metal parts and plastic parts.

Another aspect provides that the fastening portion 1.1 adjoins a head portion 1.3 of the fastening element 1, which can be designed as a sealing element, for example in the form of a mushroom head, which has a larger diameter than the fastening portion 1.1. Alternatively, the head portion 1.3 can also solely comprise at least two sectors, for example three sectors, of a mushroom head. The fastening portion 1.1 is designed in particular in the shape of a sleeve and forms a socket of the fastening element 1. The fastening portion 1.1 and the head portion 1.3 can be formed as one component, in particular made of plastic. For example, the fastening portion 1.1 and the head portion 1.3 are designed as a 2-component injection-molded plastic part. The fastening portion 1.1 can be formed from a harder plastic material, and the head portion 1.3 from a softer plastic material.

A spring element (not shown), which for example is made of metal, in particular made of a steel material, preferably spring steel, can be arranged in the receptacle 1.2.

The receptacle 1.2 can be formed in a wave-shaped manner at least in portions.

The fastening element 1 has a pin-like connecting element 5.

The fastening portion 1.1 of the fastening element 1 has a circumferential edge 1.5 below the head portion 1.3, which edge can be continuous or interrupted.

The fastening portion 1.1 can also have a connection region 1.6, in particular a latching or clamping region, in the direction of the head portion 1.3.

The first component 4 is, for example, a carrier component, in particular a body panel of a vehicle.

The fastening portion 1.1 of the fastening element 1 has the circumferential edge 1.5 or a flange for supporting the first component 4.

The fastening portion 1.1 can also have the connection region 1.6, in particular a latching or clamping region, in the direction of the head portion 1.3, by means of which the fastening element 1 is assembled on the first component 4 and is held by means of a latching or clamping connection.

Due to the enlarged contact surface of the head portion 1.3 on the first component 4 and by means of the latching or clamping connection of the connection region 1.6 between the fastening element 1 and the first component 4, the fastening element 1 is largely damped and held on the first component 4 with little noise.

The receptacle 1.2 of the fastening portion 1.1 is designed to be open at least on one side, in particular on the head side, for receiving a connecting element 5. In particular, the receptacle 1.2 can also be designed as a through opening at the bottom end as well, and can thus be open on both sides.

FIG. 4 shows a schematic sectional illustration of the fastening element 1 fastened to the second component 6 with an inserted connecting element 5, in particular a connecting bolt which can have a wave shape complementary to the receptacle 1.2. The enlarged contact surface of the head portion 1.3 serves to seal the fastening element 1 against the first component 4 to the outside.

A second component 6, for example a mounted part such as a tail light or a side marker light, can be fastened in an axially adjustable manner on the first component 4, for example a carrier component such as a body panel.

The fastening element 1 can be preassembled on the first component 4, for example on the vehicle component. By way of example, the fastening element 1 can be to arranged in a receiving opening 4.1 of the first component 4 by means of the connection region 1.6 in the form of a latching or clamping connection, and held there with a positive and/or non-positive connection.

Likewise, the connecting element 5 can be preassembled on the second component 6, for example on the tail light or side marker light. By way of example, the connecting element 5 has a threaded portion 5.1. The threaded portion 5.1 can be designed as a self-tapping or metric, in particular self-locking, thread which engages positively and/or non-positively in a receptacle 6.1 of the second component 6, and which in particular screws into the receptacle 6.1. Alternatively, the connecting element 5 can be fixed, for example pressed, glued, injected or clipped, in the second component 6.

Subsequently, the connecting element 5 with the preassembled second component 6 is fastened to the first component 4, wherein the connection of the two components 4 and 6 is axially adjustable.

The connecting element 5 is designed as a bolt which has a separating flange 5.6 for separating a first fastening region 5.4 for the fastening portion 1.1 from a second fastening region 5.5 for the second component 6. The separating flange 5.6 projects radially outwards and is designed in the shape of a disk, in the manner of a bolt collar.

In one embodiment, a drive interface 5.7 is provided on an end of the connecting element 5 opposite the threaded portion 5.1, for example an external or internal hexagonal or square head, an external or internal hexalobular, a slot, or a cross slot. The drive interface 5.7 protrudes in particular from the fastening portion 1.1 when the connecting element 5 is arranged in the receptacle 1.2, wherein the separating flange 5.6 is able to rest on the head portion 1.3.

In one embodiment, the fastening portion 1.1, as shown in FIG. 1, is already fastened to the connecting element 5 before the components 4, 6, for example in a positive and/or non-positive connection. This connection, for example by the shown complementary wave shape of the receptacle 1.2 and the connecting element 5 in the first fastening region 5.4 or by a spherical head or a spring element, can be released again by pulling the connecting element 5 out of the receptacle 1.2. For this purpose, the fastening portion 1.1 can be designed to be elastic.

By fastening the threaded portion 5.1 in the receptacle 6.1 of the second component 6, for example by screwing it in, an assembly can be formed, as shown in FIG. 4.

The assembly, comprising the second component 6 and the fastening element 1 fastened in the receptacle 6.1, can be brought to the first component 4, for example a body panel of a vehicle, wherein the fastening portion 1.1 can be inserted into a cutout 4.1 of the first component 4 and latched there, as shown in FIG. 6. FIG. 6 is a schematic view of the fastening element 1 connected to the second component 6 and of the first component 4 connected thereto. FIG. 7 shows an isometric view of the arrangement from FIG. 6.

The cutout 4.1 can have a smaller diameter than the head portion 1.3, but a larger diameter than the fastening portion 1.1 in its region directly adjacent to the head portion 1.3 above the circumferential edge 1.5. The connection regions 1.6 below the circumferential edge 1.5 in turn define a larger diameter than the cutout 4.1. The connecting regions 1.6 can be designed as protruding wings which are connected to the fastening portion 1.1 at an end pointing away from the head portion 1.3 and project radially outward at an angle to the head portion 1.3 and from the fastening portion 1.1. Due to the connecting regions 1.6 designed as protruding wings, the fastening element 1 can be moved radially relative to the first component 4.

After the second component 6 has been accordingly assembled on the first component 4 by means of the fastening element 1, an axial position of the second component 6 relative to the first component 4 can be adjusted by rotating the drive interface 5.7, as shown in FIG. 8. FIG. 8 is a schematic view of the fastening element 1 connected to the second component 6 and of the first component 4 connected thereto after the axial position has been set. If the second component 6 is now removed, as shown in FIG. 9, the bolt-shaped connecting element 5 remains in the receptacle 6.1 of the second component 6 and the fastening portion 1.1 or clip remains in the cutout 4.1 of the first component 4, for example a carrier component such as a body panel. FIG. 9 is a schematic view of the fastening element 1 after the second component 6 has been removed from the first component 4.

In the embodiment of the fastening element 1 shown in FIGS. 1 to 9, the complementary shape of the receptacle 1.2 and the connecting element 5 in the first fastening region 5.4 comprises a circumferential groove of the connecting element 5 and a complementary bulge of the receptacle 1.2.

FIG. 10 shows an alternative embodiment of the fastening element 1, wherein the complementary shape of the receptacle 1.2 and the connecting element 5 comprise, in the first fastening region 5.4, a radial bulge of the connecting element 5 and a circumferential groove complementary thereto in the receptacle 1.2.

FIG. 11 shows an alternative embodiment of the fastening element 1, wherein the complementary shape of the receptacle 1.2 and the connecting element 5 comprise, in the first fastening region 5.4, a radial bulge of the connecting element 5 and a complementary circumferential groove in the receptacle 1.2, wherein the bulge runs in the direction of the drive interface 5.7 at a shallower angle relative to the connecting element 5 than in the opposite direction, such that the connecting element 5 can be more easily inserted into the receptacle 1.2 than removed from it.

FIG. 12 shows an alternative embodiment of the connecting element 1, wherein the connecting element 5 has a circumferential groove in the first fastening region 5.4, and the receptacle 1.2 has, on its inside, elastic arms 1.7 complementary thereto which engage in the groove. The elastic arms 1.7 can be fastened to the receptacle 1.2 at their end facing the head portion 1.3, and protrude in the opposite direction. The groove in the connecting element 5 can extend in the direction of the drive interface 5.7 at a steeper angle relative to the connecting element 5 than in the opposite direction, such that the connecting element 5 can be more easily inserted into the receptacle 1.2 than pulled out of it.

FIG. 13 shows an alternative embodiment of the connecting element 1, wherein the connecting element 5 has a circumferential groove in the first fastening region 5.4, and the receptacle 1.2 has, on its inside, a bulge complementary thereto which engages in the groove. The groove in the connecting element 5 can extend in the direction of the drive interface 5.7 at a steeper angle relative to the connecting element 5 than in the opposite direction, such that the connecting element 5 can be more easily inserted into the receptacle 1.2 than pulled out of it.

FIG. 14 shows an alternative embodiment of the connecting element 1, wherein the connecting element 5 is formed cylindrically in the first fastening region 5.4, and the receptacle 1.2 is also formed cylindrically on its inside, complementary thereto.

FIG. 15 shows an alternative embodiment of the connecting element 1, wherein the connecting element 5 is formed substantially cylindrically in the first fastening region 5.4 and provided with a corrugation 5.8, and the receptacle 1.2 can likewise be formed substantially cylindrically on its inside. A spring element 2 is arranged in the receptacle 1.2 and is firmly connected axially in both directions to an inside of the receptacle 1.2.

Such a spring element 2 axially fixed in both directions within the fastening portion 1.1 in the receptacle 1.2 within the fastening portion, can transmit forces, such as an insertion force and an extraction force, in particular compressive or tensile forces, axially in both directions, and can dissipate them in the direction of the receptacle 1.2, such that the fastening element 1 can be used multiple times.

In one possible embodiment, the fastening portion 1.1 is made of plastic and the spring element 2 is made of metal.

The spring element 2 comprises, for example, a base body from which spring arms protrude radially outward, which engage positively and/or non-positively in the inside of the receptacle 1.2. Axial forces and their dissipation in both directions can be adjusted in a targeted manner by means of the spring arms.

The base body of the spring element 2 is, for example, sleeve-shaped. The plurality of spring arms is arranged or formed one above the other in a plurality of rows, for example along a longitudinal extension of the base body. The spring arms can be arranged or formed diametrically opposite each other with respect to the base body. Such an arrangement, in particular a two-sided or two-row arrangement, of spring arms on the base body enables symmetrical force transmission and dissipation.

Alternatively, a one-sided or one-row arrangement of spring arms can be formed on the base body, which allows for an asymmetrical force transmission and dissipation.

In addition, the base body can have a wave-shaped portion in some regions outside of the rows of spring arms. This wave-shaped portion of the base body allows for a frictional or clamping connection with the inside of the receptacle 1.2 outside of the positive and/or non-positive connection of the spring arms with the inside.

The spring arms in the shown embodiment can project radially outwards and then penetrate into the inside of the receptacle 1.2, when inserted in the receptacle 1.2, and form a positive and/or non-positive connection with the inside of the receptacle 1.2.

In addition, the base body can have spring arms according to FIG. 13 which are directed radially inward and which protrude radially inward from the base body.

For example, adjacent spring arms and at least one of the rows have spring ends directed alternately radially outward and radially inward.

In addition, the spring arms of one or of each of the rows can be arranged at an axial distance from each other. This enables axial adjustability of the connection, for example by means of corresponding distances in adjustment steps. This enables axial adjustment steps to compensate for tolerances, in particular small component tolerances, in small steps of, for example, 0.2 cm to 1 cm, in particular 0.35 cm.

The spring arms can thereby be designed as latching arms, ratchets, or clamping arms, or in another suitable shape which enables a positive and/or non-positive connection to an adjoining surface, such as the inside of the receptacle.

In all embodiments, the receptacle 1.2 can be formed like a funnel in the region of the head portion 1.3, in order to facilitate the insertion of the connecting element 5.

### LIST OF REFERENCE SIGNS

1 Fastening element
1.1 Fastening portion
1.2 Receptacle
1.3 Head portion
1.5 Edge
1.6 Connecting region
1.7 Arms
2 Spring element
4 First component
4.1 Receiving opening/cutout
5 Connecting element
5.1 Threaded portion
5.4 First fastening region
5.5 Second fastening region
5.6 Separating flange
5.7 Drive interface
5.8 Corrugation
6 Second component
6.1 Receptacle

What is claimed is:

1-12. (canceled)

13. A fastening element for connecting a first component to a second component, wherein the fastening element has:
a pin-like connecting element having a first fastening region and a second fastening region,
a retaining element having a fastening portion which is provided with a receptacle for receiving the first fastening region, wherein the retaining element is configured for fastening in a cutout of the first component,
wherein the second fastening region has a portion for engaging in a receptacle of the second component, wherein a drive interface is provided on the connecting element so that the connecting element held in the receptacle is movable.

14. The fastening element according to claim 13, wherein the retaining element is designed as a clip which is designed to snap into place in the cutout of the first component.

15. The fastening element according to claim 13, wherein the portion is designed as a threaded portion.

16. The fastening element according to claim 13, wherein the drive interface is arranged at one end of the connecting element, wherein the drive interface and/or the retaining element are/is designed so that the drive interface is accessible when the first fastening region is arranged in the receptacle.

17. The fastening element according to claim 16, wherein the drive interface protrudes from the receptacle when the first fastening region is arranged in the receptacle.

18. The fastening element according to claim 13, wherein the drive interface is configured to rotate the connecting element and comprises an external or internal hexagonal or square head, an external or internal hexalobular, a slot or a cross slot.

19. The fastening element according to claim 13, wherein the connecting element is held in the receptacle so as to be rotatable, releasable, but inhibited against being pulled out.

20. The fastening element according to claim 13, wherein the fastening portion is elastic in the region of the receptacle.

21. The fastening element according to claim 13, wherein the receptacle and the first fastening region have mutually complementary shapes.

22. The fastening element according to claim 13, wherein the receptacle and the first fastening region comprise mutually complementary wave shapes and/or a spherical head and/or a spring element and/or a circumferential groove and elastic arms complementary thereto.

23. The fastening element according to claim 13, wherein a separating flange is provided on the connecting element for separating the first fastening region from the second fastening region.

24. The fastening element according to claim 13, wherein the retaining element further has a head portion which has a larger diameter than the fastening portion, wherein, on the fastening region, at least two connecting regions are formed in the form of flexible, protruding wings which, at an end pointing away from the head portion, are connected to the fastening portion and project radially outward and from the fastening portion at an angle to the head portion
